(19) United States
(12) Patent Application Publication
(10) Pub. No.: US 2026/0241701 A1
(43) Pub. Date: Aug. 20, 2026

(54) RECORDING HEAD AND INKJET RECORDING APPARATUS PROVIDED THEREWITH

(71) Applicant: KYOCERA Document Solutions Inc., Osaka (JP)

(72) Inventor: Naoto MIYAKOSHI, Osaka (JP)

(73) Assignee: KYOCERA Document Solutions Inc., Osaka (JP)

(21) Appl. No.: 19/531,073

(22) Filed: Feb. 5, 2026

(30) Foreign Application Priority Data
Feb. 17, 2025 (JP) 2025-023327

(51) Int. Cl. B41J 2/19; B41J 2/175

(52) U.S. Cl. CPC B41J 2/19; B41J 2/17596

(57) ABSTRACT

A recording head includes an ink ejection portion and an ink reservoir coupled to the ink ejection portion. The ink reservoir includes an in-head flow passage coupled to a common flow passage for circulating ink, an air bubble separation portion that separates air bubbles contained in ink flowing through the in-head flow passage, a valve member that opens and closes an air bubble discharge port formed in a top part of the air bubble separation portion, and an ink discharge flow passage extending downward from an ink inflow port formed in a lower end part of the air bubble separation portion and coupled to the ink ejection portion. The in-head flow passage is coupled substantially horizontally to the ink discharge flow passage and a junction portion between the in-head and the ink discharge flow passages is below the ink inflow port.

### INCORPORATION BY REFERENCE

This application is based on and claims the benefit of priority from Japanese Patent Application No. 2025-023327 filed on February 17, 2025, the contents of which are hereby incorporated by reference.

### BACKGROUND

The present disclosure relates to a recording head incorporated in an inkjet recording apparatus, and to an inkjet recording apparatus provided with a recording head.

In conventional inkjet recording apparatuses such as inkjet printers, ink is ejected from ejection nozzles provided in a recording head and the ejected ink adheres to a recording medium such as a sheet to form dots. The ink is fed out from an ink container and a predetermined amount of it is stored in a subsidiary tank, then fed from the subsidiary tank to the recording head.

### SUMMARY

According to one aspect of the present disclosure, a recording head includes an ink ejection portion and an ink reservoir and is incorporated in an inkjet recording apparatus for recording an image on a recording medium. The ink ejection portion has a plurality of ejection nozzles through which ink is ejected. The ink reservoir is coupled to the ink ejection portion. The ink reservoir includes an in-head flow passage coupled to a common flow passage through which the ink is circulated, an air bubble separation portion that separates air bubbles contained in the ink flowing through the in-head flow passage, a valve member that opens and closes an air bubble discharge port formed in a top part of the air bubble separation portion, and an ink discharge flow passage extending downward from an ink inflow port formed in a lower end part of the air bubble separation portion and coupled to the ejection nozzles in the ink ejection portion. The in-head flow passage is coupled substantially horizontally to the ink discharge flow passage and a junction portion between the in-head and the ink discharge flow passages is located below the ink inflow port.

### BRIEF DESCRIPTION OF THE DRAWINGS

FIG. 1 is an illustrative diagram showing an outline configuration of a printer as an inkjet recording apparatus according to one embodiment of the present disclosure

FIG. 2 is a plan view of a recording portion provided in the printer.

FIG. 3 is a side view of a recording head in a line head in the recording portion.

FIG. 4 is a plan view of the recording head as seen from the ink ejection surface side.

FIG. 5 is a schematic diagram showing an ink feeding passage, a cleaning liquid feeding passage, and the internal structure of the recording heads, which together constitute a line head in the printer.

FIG. 6 is a side sectional view of the recording head as seen from upstream in the sheet conveyance direction.

FIG. 7 is a sectional part view around an air bubble separation portion in the recording head.

FIG. 8 is a sectional part view around the air bubble separation portion, showing how air bubbles in the air bubble separation portion are discharged with a valve member disposed in an open position.

### DETAILED DESCRIPTION

### 1. Construction of an Inkjet Recording Apparatus

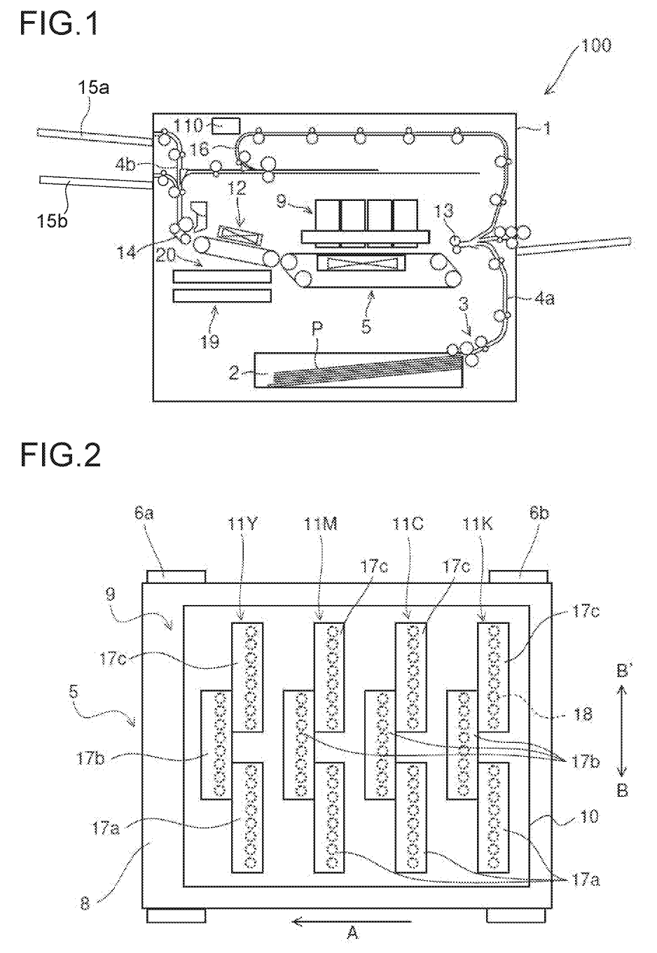

An embodiment of the present disclosure will be described below with reference to the accompanying drawings. FIG. 1 is an illustrative diagram showing an outline configuration of a printer 100 as an inkjet recording apparatus according to one embodiment of the present disclosure. The printer 100 includes a sheet feed cassette 2 as a sheet storage portion. The sheet feed cassette 2 is disposed in a lower part inside a printer body 1. The sheet feed cassette 2 stores inside it sheets of paper P as one example of a recording medium.

Downstream of the sheet feed cassette 2 along the sheet conveyance direction, that is, at the upper right side of the sheet feed cassette 2 in FIG. 1, a sheet feeding device 3 is disposed. The sheet feeding device 3 feeds out the sheets P, separately one by one, to the upper right of the sheet feed cassette 2 in FIG. 1.

The printer 100 has a first sheet conveyance passage 4a in it. The first sheet conveyance passage 4a is located at the upper right of the sheet feed cassette 2, that is, in the direction in which it feeds sheets. A sheet P fed out of the sheet feed cassette 2 is conveyed by the first sheet conveyance passage 4a vertically upward along a side face of the printer body 1.

At the downstream end of the first sheet conveyance passage 4a along the sheet conveyance direction, a pair of registration rollers 13 is provided. Closely downstream of the pair of registration rollers 13 along the sheet conveyance direction, a first conveyance unit 5 and a recording portion 9 are disposed. The sheet P fed out of the sheet feed cassette 2 passes through the first sheet conveyance passage 4a and reaches the pair of registration rollers 13. The pair of registration rollers 13 feeds out the sheet P toward the first conveyance unit 5 (in particular, a first conveyance belt 8, which will be described later), while correcting a skew of the sheet P and coordinating timing with ink ejection operation in the recording portion 9.

The sheet P fed out to the first conveyance unit 5 by the pair of registration rollers 13 is conveyed by the first conveyance belt 8 to a position opposite the recording portion 9 (in particular, recording heads 17a to 17c, which will be described later). The recording portion 9 ejects ink onto the sheet P and thereby records an image on the sheet P. At this time, the ejection of ink by the recording portion 9 is controlled by a control device 110 within the printer 100.

Downstream of (in FIG. 1, at the left of) the first conveyance unit 5 along the sheet conveyance direction, a second conveyance unit 12 is disposed. The sheet P having the image recorded on it by the recording portion 9 is fed to the second conveyance unit 12. The ink ejected onto the surface of the sheet P dries while passing through the second conveyance unit 12.

Downstream of the second conveyance unit 12 along the sheet conveyance direction, near the left side face of the printer body 1, a decurler 14 is provided. The sheet P having ink dried in the second conveyance unit 12 is fed to the decurler 14, which corrects a curl that has developed in the sheet P.

Downstream of (in FIG. 1, above) the decurler 14 along the sheet conveyance direction, a second sheet conveyance passage 4b is provided. When duplex printing is not performed, the sheet P having passed through the decurler 14 passes through the second sheet conveyance passage 4b and is discharged to a sheet discharge tray 15a provided on the left side face of the printer 100, outside it. Below the sheet discharge tray 15a, a sub discharge tray 15b is provided to which are discharged unnecessary sheets P (waste sheets) with print defects and the like.

In an upper part of the printer body 1, above the recording portion 9 and the second conveyance unit 12, a reversing conveyance passage 16 for duplex printing is provided. When duplex printing is performed, the sheet P that has undergone recording on one side (first side) and that has passed through the second conveyance unit 12 and the decurler 14 is fed through the second sheet conveyance passage 4b to the reversing conveyance passage 16.

The sheet P fed to the reversing conveyance passage 16 then has its conveyance direction switched for recording on the other side (second side). The sheet P then passes through an upper part of the printer body 1 to be fed rightward, and is then fed via the pair of registration rollers 13 to the first conveyance unit 5 again, this time with the second side up. In the first conveyance unit 5, the sheet P is conveyed to a position opposite the recording portion 9, where the recording portion 9 ejects ink to record an image on the second side. The sheet P having undergone recording on both sides passes through the second conveyance unit 12, the decurler 14, and the second sheet conveyance passage 4b in this order and is discharged to the sheet discharge tray 15a.

Below the second conveyance unit 12, a maintenance unit 19 and a cap unit 20 are disposed. When the printer 100 performs purging, the maintenance unit 19 moves horizontally to under the recording portion 9; there it wipes off the ink pushed out through ink ejection ports in the recording heads and collects the ink so wiped off. Purging denotes operation of forcibly pushing ink out through the ink ejection ports in the recording heads to remove ink with increased viscosity, foreign matter, and air bubbles inside the ink ejection ports. When the cap unit 20 caps the ink ejection surface of the recording heads, it moves horizontally to under the recording portion 9 and then moves upward to be attached to the bottom surface of the recording heads.

FIG. 2 is a plan view of the recording portion 9. The recording portion 9 includes a head housing 10 and line heads 11Y, 11M, 11C, and 11K. The line heads 11Y to 11K are held on the head housing 10 at such a height as to form a predetermined interval (e.g., 1 mm) relative to the conveyance surface of a first conveyance belt 8, which is an endless belt stretched around a plurality of rollers including a driving roller 6a, a driven roller 6b, and a tension roller (not shown). The driving roller 6a makes the first conveyance belt 8 travel in the conveyance direction (arrow-A direction) of the sheet P.

The line heads 11Y to 11K each include a plurality of (here, three) recording heads 17a to 17c. The recording heads 17a to 17c are disposed in a staggered row along the sheet width direction (arrow-BB’ direction), which is orthogonal to the sheet conveyance direction (arrow-A direction). The recording heads 17a to 17c have a plurality of ink ejection ports 18 (nozzles). The ink ejection ports 18 are disposed in a row at equal intervals along the width direction of the recording heads 17a to 17c, that is, the sheet width direction (arrow-BB’ direction). From the line heads 11Y to 11K, through the ink ejection ports 18 in the recording heads 17a to 17c, inks of different colors, specifically yellow (Y), magenta (M), cyan (C), and black (K), are ejected toward the sheet P being conveyed on the first conveyance belt 8.

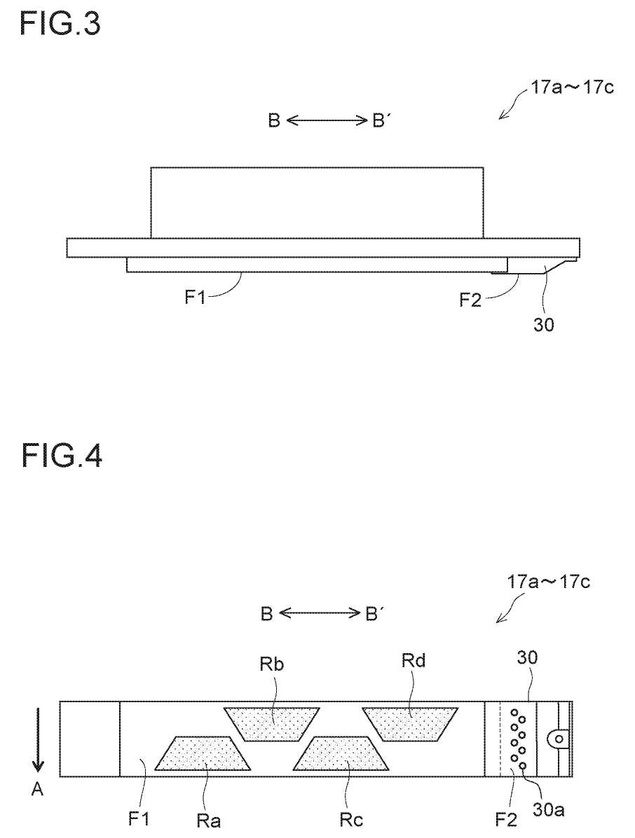

FIG. 3 is a side view of the recording head 17a to 17c in the line heads 11Y to 11K in the recording portion 9, and FIG. 4 is a plan view of the recording head 17a to 17c as seen from the ink ejection surface F1 side. The recording heads 17a to 17c are shaped and configured identically and so FIGS. 3 and 4 show the recording heads17a to 17c in a single figure. As shown in FIGS. 3 and 4, on the ink ejection surface (nozzle surface) F1 of the recording head 17a to 17c, a plurality (here, four blocks) of nozzle regions Ra to Rd are provided, in which a large number of ink ejection ports 18 (see FIG. 2) are arrayed. The ink ejection surface F1 is formed of, for example, SUS (stainless steel).

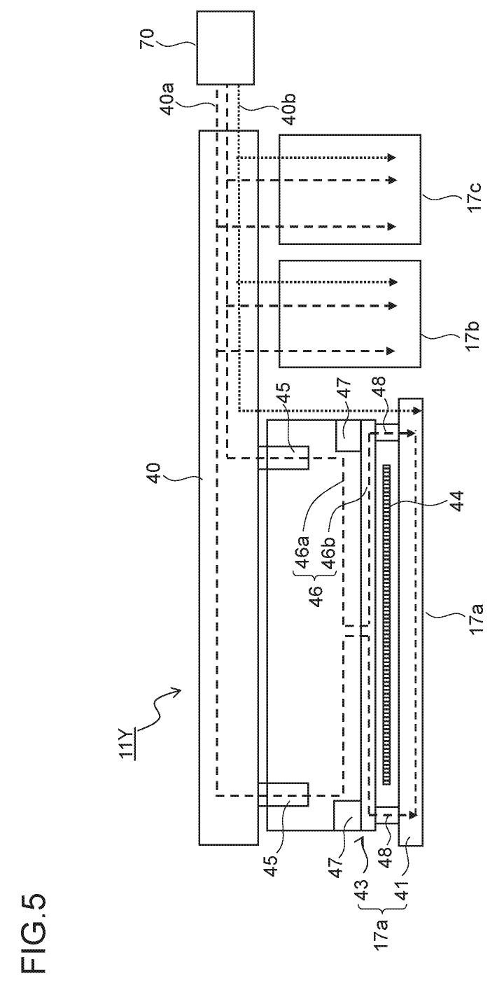

The recording heads17a to 17c in the line heads 11C to 11K are supplied with inks of four colors (cyan, magenta, yellow, and black) from a liquid supplying mechanism 70 (see FIG. 5) respectively according to the colors for which the line heads 11C to 11K are intended.

In response to a control signal from the control device 110 (see FIG. 1), the recording heads 17a to 17c eject from the ink ejection ports 18 inks toward a sheet P being conveyed on, by being held by suction on, the conveyance surface of the first conveyance belt 8 according to image data received from an external computer. As a result, on the sheet P on the first conveyance belt 8, a color image having inks of four colors, namely cyan, magenta, yellow, and black, laid over each other is formed. In one end part of the recording head 17a to 17c along its longitudinal direction (arrow-BB’ direction), which is orthogonal to the sheet conveyance direction (arrow-A direction), a cleaning liquid feed portion 30 that feeds a cleaning liquid is provided. In the cleaning liquid feed portion 30, a large number of cleaning liquid feeding ports 30a are formed.

On the printer 100, to clean the ink ejection surface F1 of the recording heads 17a to 17c, when printing is started after a long period of non-operation or between sessions of printing, recovery operation for the recording heads 17a to 17c is performed in the following manner: ink is pushed out through the ink ejection ports 18 in all the recording heads 17a to 17c (purging) and the cleaning liquid is supplied from the cleaning liquid feeding ports 30a to a cleaning liquid supply surface F2; then the ink ejected on the ink ejection surface F1 is together with the cleaning liquid wiped off with a wiper (not shown) in preparation for subsequent printing. The ink and the cleaning liquid wiped off the ink ejection surface F1 is collected in an ink receiving portion (not shown).

### 2. Configuration of Flow Passages Including the Recording Head

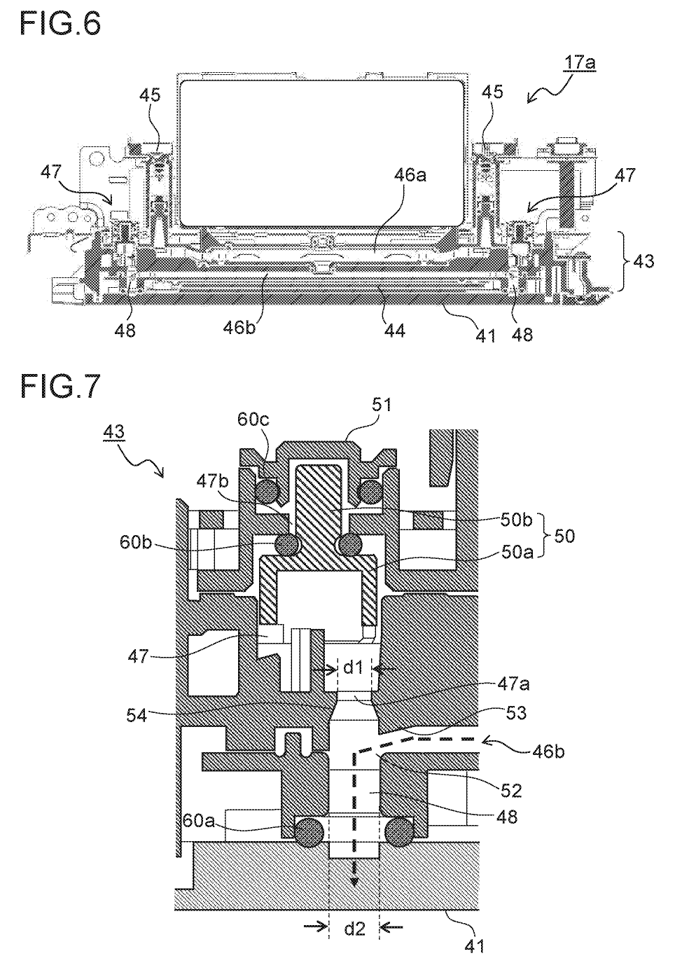

FIG. 5 is a schematic diagram showing an ink feeding passage 40a, a cleaning liquid feeding passage 40b, and the internal structure of the recording heads 17a to 17c, which together constitute the line head 11Y in the printer 100. FIG. 6 is a side sectional view of the recording head 17a as seen from upstream in the sheet conveyance direction. The line heads 11M to 11K have a quite similar configuration to the line head 11Y and therefore their description will be omitted. The recording heads 17a to 17c have an identical internal structure, so FIGS. 5 and 6 show the internal structure of only the recording head 17a.

As shown in FIG. 5, to the recording heads 17a to 17c are connected a common flow passage 40 that the ink and the cleaning liquid pass through. In the common flow passage 40 are formed two ink feeding passages 40a that the ink passes through and one cleaning liquid feeding passage 40b that the cleaning liquid passes through. The upstream ends of the ink and cleaning liquid feeding passages 40a and 40b are connected to the liquid feeding mechanism 70. The liquid feeding mechanism 70 is configured with tanks that store the ink and the cleaning liquid and pumps that pump up the ink and the cleaning liquid (neither are shown).

At their downstream ends, the two ink feeding passages 40a branch each into three paths , and hence into a total of six paths, and are connected two by two to the ink ejection ports 18 (see FIG. 2) in the recording heads 17a to 17c. At its downstream end the cleaning liquid feeding passage 40b branches into three paths and is connected to the cleaning liquid feed portion 30 (see FIGS. 3 and 4) in the recording heads 17a to 17c, respectively. The unit including the recording heads 17a to 17c and the common flow passage 40 is called a head unit.

Of the two ink feeding passages 40a, one is used to feed the ink from the liquid feeding mechanism 70 to the recording heads 17a to 17c and the other is used to collect the ink from the recording heads 17a to 17c to the liquid feeding mechanism 70. When images that require a large amount of ink to be ejected, the two ink feeding passages 40a can both be used to feed the ink to the recording heads 17a to 17c.

The recording heads 17a to 17c are individually attachable to and removable from the common flow passage 40. More specifically, three joint mechanisms 45 that connect the recording heads 17a to 17c to two ink feeding passages 40a and one cleaning liquid feeding passage 40b are fastened with fastening screws (not shown) from above the common flow passage 40. In FIGS. 5 and 6, only two joint mechanisms 45 connected to the two ink feeding passages 40a are shown.

The recording heads 17a to 17c have an ink ejection portion 41, an ink reservoir 43, a heater 44, and the joint mechanism 45. The ink ejection portion 41 is provided with the ink ejection surface F1 in which a large number of ink ejection ports 18 are arrayed and the cleaning liquid feed portion 30 that feeds the cleaning liquid (for both, see FIG. 4).

The ink reservoir 43 includes an in-head flow passage 46, an air bubble separation portion 47, and an ink discharge flow passage 48. A pair of each of the in-head flow passage 46, the air bubble separation portion 47, and the ink discharge flow passage 48 are provided to correspond to two joint mechanisms 45.

Between the ink ejection portion 41 and the ink reservoir 43, the heater 44 is disposed. As necessary, the heater 44 heats the ink flowing through the in-head flow passage 46 (a second flow passage 46b, which will be described later) to a predetermined temperature and heats the ink ejection portion 41 for smooth ejection of the ink from the ink ejection ports 18.

The in-head flow passage 46 has a first flow passage 46a and a second flow passage 46b. The first flow passage 46a extends from two joint mechanisms 45 downward inside the ink reservoir 43 and bends inward in the width direction. The second flow passage 46b is coupled to a downstream end part of the first flow passage 46a in a middle part of the recording head 17a in the width direction and extends from inward to outward in the width direction inside the ink reservoir 43. The second flow passage 46b is provided in the ink reservoir 43 at a position adjacent to the heater 44.

The air bubble separation portion 47 is disposed downstream of the second flow passage 46b, temporarily stores the ink to be fed from the ink reservoir 43 to the ink ejection portion 41, and separates the air bubbles contained in the ink. The ink discharge flow passage 48 is coupled to a downstream end part of the second flow passage 46b and extends downward inside the ink reservoir 43 toward the ink ejection portion 41.

The ink fed from the ink feeding passages 40a via the joint mechanism 45 to the ink reservoir 43 passes through the first flow passage 46a, the second flow passage 46b, the air bubble separation portion 47, and the ink discharge flow passage 48 in this order, and is then fed out by the ink ejection portion 41 to be ejected from the ink ejection ports 18.

### 3. Configuration Around the Air Bubble Separation Portion in the Ink Reservoir

As a distinctive feature of the present disclosure, a specific configuration around the air bubble separation portion 47 in the recording head 17a will be described below. FIG. 7 is a sectional part view around the air bubble separation portion 47 in the recording head 17a. While the following description deals with, as an example, the configuration around the air bubble separation portion 47 disposed at one side (left side in FIG. 6) of the recording head 17a, the configuration at the other side (right side in FIG. 6) is identical. Also, the recording heads 17b and 17c have the identical configuration.

As shown in FIG. 7, the air bubble separation portion 47 has an ink inflow port 47a and an air bubble discharge port 47b. The ink inflow port 47a is formed in a lower end part of the air bubble separation portion 47. The air bubble discharge port 47b is formed in an upper end part of the air bubble separation portion 47. To the ink inflow port 47a is coupled one end part (upper end part) of the ink discharge flow passage 48 and another end part (lower end part) of the ink discharge flow passage 48 is coupled to the ink ejection portion 41. A lower end part of the ink discharge flow passage 48 is fitted with a first O-ring 60a which seals the gap between the ink discharge flow passage 48 and the ink ejection portion 41.

Inside the air bubble separation portion 47 is disposed a valve member 50 that is movable in the up-down direction. The valve member 50 has a large-diameter portion 50a and a small-diameter portion 50b. The large-diameter portion 50a is located below the air bubble discharge port 47b and the small-diameter portion 50b projects upward, out through the air bubble discharge port 47b. On the outer circumferential surface of the large-diameter portion 50a, an external thread (not shown) in a spiral shape is formed and on the inner circumferential surface of the air bubble separation portion 47, an internal thread (not shown) in a spiral shape is formed.

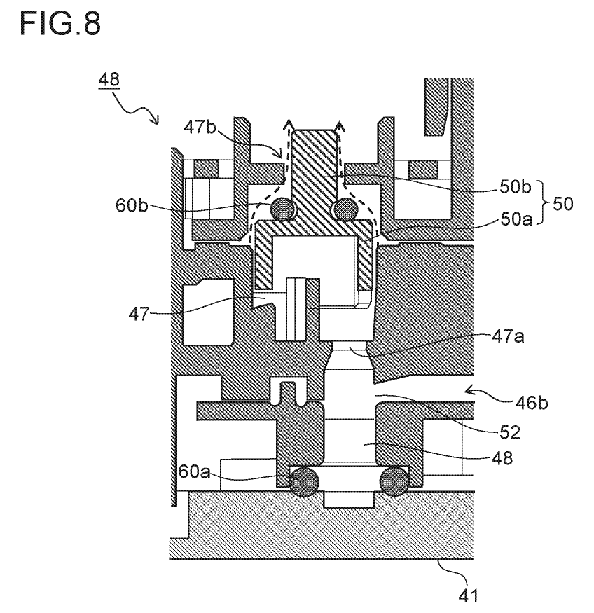

Holding the small-diameter portion 50b and rotating the valve member 50 causes the external thread formed in the large-diameter portion 50a to slide along the internal thread formed on the air bubble separation portion 47. As a result, the valve member 50 reciprocates up and down inside the air bubble separation portion 47 and is disposed selectively in a closing position (see FIG. 7) where it keeps the air bubble discharge port 47b closed or in an open position (see FIG. 8) where it leaves the air bubble discharge port 47b open.

At the boundary between the large-diameter portion 50a and the small-diameter portion 50b, a second O-ring 60b is fitted which seals the gap between the air bubble discharge port 47b and the valve member 50. Disposing the valve member 50 in the closing position brings the second O-ring 60b into pressed contact with the circumferential edge of the air bubble discharge port 47b and closes the air bubble discharge port 47b.

An upper end part of the air bubble separation portion 47 is fitted with a lid member 51. The lid member 51 covers the air bubble discharge port 47b and the small-diameter portion 50b of the valve member 50. The circumferential edge of the lid member 51 is fitted with a third O-ring 60c which seals the gap between the air bubble separation portion 47 and the lid member 51.

FIG. 8 is a sectional part view around the air bubble separation portion 47, showing how air bubbles in the air bubble separation portion 47 are discharged with the valve member 50 disposed in the open position. With reference to FIGS. 7 and 8, a method for loading ink in the recording heads 17a to 17c at the shipment of the printer 100 will be described.

As shown in FIG. 8, when ink is loaded in the recording head 17a, the lid member 51 fitted to the upper end part of the air bubble separation portion 47 is removed. Then, the valve member 50 is rotated in a predetermined direction to be disposed in the open position. In this state, the liquid feeding mechanism 70 (see FIG. 5) is driven to feed ink via the ink feeding passages 40a and 40b to the recording head 17a. The ink passes through the joint mechanism 45 and the first and second flow passages 46a and 46b and flows into the ink discharge flow passage 48.

The ink ejection portion 41 connected to the lower end part of the ink discharge flow passage 48 is provided with mesh-like fine ink flow passages (not shown) that leads to a large number of ink ejection ports 18 (see FIG. 2). Thus, the flow passage resistance to the ink flowing from the ink discharge flow passage 48 toward the ink ejection portion 41 is greater than the flow passage resistance to the ink flowing toward the air bubble separation portion 47. Consequently, the ink flowing into the ink discharge flow passage 48 is preferentially fed to the air bubble separation portion 47 and this eliminates the risk of its leaking from the ink ejection ports 18.

The air bubbles contained in the ink having flowed into the air bubble separation portion 47 move together with the ink from the ink inflow port 47a to the air bubble separation portion 47. Meanwhile, the valve member 50 is disposed in the open position and a gap is formed between the second O-ring 60b and the air bubble discharge port 47b. Thus, the air bubbles having entered the air bubble separation portion 47 together with the ink are discharged out through the gap (indicated by broken lines in FIG. 8). Keeping feeding the ink until ink overflows out through the air bubble discharge port 47b permits complete discharge of the air bubbles in the joint mechanism 45 and the first and second flow passages 46a and 46b.

When the ink starts to overflow through the air bubble discharge port 47b, the driving of the liquid feeding mechanism 70, and hence the feeding of ink, is stopped. After that, the valve member 50 is rotated reversely to be disposed in the closing position to complete the loading of the ink in the recording head 17a.

In this embodiment, the second flow passage 46b is not directly coupled to the air bubble separation portion 47; instead, it is coupled via the ink discharge flow passage 48 to the air bubble separation portion 47. More specifically, a junction portion 52 between the second flow passage 46b and the ink discharge flow passage 48 is located below the ink inflow port 47a in the air bubble separation portion 47.

With the configuration described above, the air bubble separation portion 47 is located above, away from, the ink flow (indicated by a broken line in FIG. 7) through the second flow passage 46b and the ink discharge flow passage 48. Thus, during purge operation in which ink is pushed out through the ink ejection ports 18, even if ink flows at high velocity through the second flow passage 46b and the ink discharge flow passage 48, no ink moves in a top part of the air bubble separation portion 47 (an air bubble retention region).

As a result, the air bubbles staying in the top part of the air bubble separation portion 47 are less likely to be drawn into the ink flow and this eliminates the risk of the air bubbles being fed via the ink discharge flow passage 48 to the ink ejection ports 18. This effectively prevents ink ejection failure (pin hole) due to the air bubbles clogging the ink ejection ports 18.

In this embodiment, an inclined portion 53 is formed in the second flow passage 46b coupled to the ink discharge flow passage 48. The inclined portion 53 is formed closely upstream (right side in FIG. 7) of the junction portion 52, on the inner surface of the second flow passage 46b closer to the air bubble separation portion 47 (upside in FIG. 7). The inclined portion 53 inclines, from upstream toward downstream (right to left in FIG. 7) with respect to the ink flow in the second flow passage 46b, in the direction away from the air bubble separation portion 47 (downside of FIG. 7).

With the configuration described above, the ink flowing through the second flow passage 46b strikes the inclined portion 53 and changes its direction along the inclined portion 53 to the direction (down direction) toward the ink ejection portion 41. This makes the ink having flowed into the ink discharge flow passage 48 less likely to flow in the direction toward the air bubble separation portion 47 and makes the ink less likely to move in the air bubble separation portion 47.

In this embodiment, the inner diameter d1 of the ink inflow port 47a formed in the air bubble separation portion 47 is smaller than the inner diameter d2 of the ink discharge flow passage 48. In other words, the cross-sectional area of the flow passage from the ink discharge flow passage 48 toward the air bubble separation portion 47 is smaller than the cross-sectional area of the flow passage from the ink discharge flow passage 48 toward the ink ejection portion 41.

With the configuration described above, reducing the cross-sectional area of the flow passage toward the air bubble separation portion 47 produces a flow passage resistance difference with the flow passage toward the ink ejection portion 41. As a result, the ink is less likely to flow into the air bubble separation portion 47, making the ink even less likely to move in the air bubble separation portion 47.

Moreover, between the ink inflow port 47a and the ink discharge flow passage 48, a coupling portion 54 in the shape of an inverted taper from the ink discharge flow passage 48 toward the ink inflow port 47a is formed. This permits the cross-sectional area of the flow passage from the ink discharge flow passage 48 toward the ink inflow port 47a to narrow continuously (smoothly), with no step formed near the ink inflow port 47a. Thus, even if the ink flowing toward the air bubble separation portion 47 contains air bubbles, the air bubbles can move smoothly to the top part of the air bubble separation portion 47 without getting caught at a step part.

In the conventional configuration where the second flow passage 46b is coupled to the air bubble separation portion 47, it is necessary to extend the in-head flow passage 46, which is laid to extend downward from the top of the ink reservoir 43, further upward, resulting in a complex flow passage configuration. In contrast, in this embodiment, the second flow passage 46b joins with the ink discharge flow passage 48 below the air bubble separation portion 47, and so the in-head flow passage 46 can have a simple flow passage configuration composed solely of the first and second flow passages 46a and 46b.

The present disclosure can be implemented in any manner other than as in the embodiment described above, and allows for any modifications without departure from the spirit of the present disclosure. While the embodiment described above deals with a configuration in which three recording heads 17a to 17c are fitted to one head unit; instead, it is also possible to employ a configuration in which only one recording head fitted to one head unit or a configuration in which two, four, or more recording heads fitted to it.

While the embodiment described above deals with, as an example of an inkjet recording apparatus, a color printer that records color images using ink of four colors, it is also possible to use the recording head of this embodiment in a monochrome printer that records monochrome images using black ink.

The present disclosure finds application in inkjet recording apparatuses such as inkjet printers including a recording head.

What is claimed is:

1. A recording head incorporated in an inkjet recording apparatus for recording an image on a recording medium, comprising:
an ink ejection portion that has a plurality of ejection nozzles through which ink is ejected; and
an ink reservoir that is coupled to the ink ejection portion,
wherein
the ink reservoir includes:
an in-head flow passage that is coupled to a common flow passage through which the ink is circulated;
an air bubble separation portion that separates air bubbles contained in the ink flowing through the in-head flow passage;
a valve member that opens and closes an air bubble discharge port formed in a top part of the air bubble separation portion; and
an ink discharge flow passage that extends downward from an ink inflow port formed in a lower end part of the air bubble separation portion, the ink discharge flow passage being coupled to the ejection nozzles in the ink ejection portion, and
the in-head flow passage is coupled substantially horizontally to the ink discharge flow passage and a junction portion between the in-head flow passage and the ink discharge flow passage is located below the ink inflow port.

2. The recording head according to claim 1, wherein
the in-head flow passage has an inclined portion closely upstream of the junction portion, on an inner surface thereof closer to the air bubble separation portion, and
the inclined portion inclines, from upstream toward downstream with respect to an ink flow in the in-head flow passage, in a direction away from the air bubble separation portion.

3. The recording head according to claim 1, wherein
an inner diameter of the ink inflow port is smaller than an inner diameter of the ink discharge flow passage.

4. The recording head according to claim 3, wherein
between the ink inflow port and the ink discharge flow passage, a coupling portion in a shape of an inverted taper from the ink discharge flow passage toward the ink inflow port is formed.

5. The recording head according to claim 1, wherein
the in-head flow passage has
a first flow passage which is coupled to the common flow passage and which extends substantially horizontally from outward to inward inside the ink reservoir, and
a second flow passage which is coupled to a downstream end part of the first flow passage and which extends substantially horizontally from inward to outward inside the ink reservoir, the second flow passage being coupled to the ink discharge flow passage.

6. The inkjet recording apparatus comprising:
the recording head according to claim 1, and
a liquid feeding mechanism that feeds one or more liquids including the ink via the common flow passage to the recording head.
